(19) United States
(12) Patent Application Publication
(10) Pub. No.: US 2025/0267242 A1
(43) Pub. Date: Aug. 21, 2025

(54) PROJECTION METHOD, SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventors: Kota Takeuchi, Azumino-shi (JP); Kosuke Saku, Matsumoto-shi (JP)

(73) Assignee: SEIKO EPSON CORPORATION, Tokyo (JP)

(21) Appl. No.: 19/056,860

(22) Filed: Feb. 19, 2025

(30) Foreign Application Priority Data
Feb. 20, 2024 (JP) 2024-023491

(51) Int. Cl. H04N 9/31

(52) U.S. Cl. CPC H04N 9/3185; H04N 9/3188; H04N 9/3194

(57) ABSTRACT

A projection method includes: projecting a projection image onto projection surface from projector; acquiring picked-up image formed by picking up projection image with camera having a first internal parameter; generating a first correspondence relationship in which coordinates of a plurality of first pixels in picked-up image and coordinates of a plurality of second pixels on display panel of projector are associated with each other; acquiring state information indicating a state of an optical system of projector; estimating a second internal parameter of optical system, based on a second correspondence relationship in which the second internal parameter and the state of the optical system are associated with each other, and the state information; and estimating external parameter indicating one or both of a position and an attitude of the projector in relation to the camera, based on the first internal parameter, the first correspondence relationship, and the second internal parameter.

The present application is based on, and claims priority from JP Application Serial Number 2024-023491, filed Feb. 20, 2024, the disclosure of which is hereby incorporated by reference herein in its entirety.

### BACKGROUND

### 1. Technical Field

The present disclosure relates to a projection method, a system, and a non-transitory computer-readable storage medium storing a program.

### 2. Related Art

For example, US 2008/0285843 discloses a technique of capturing, with a camera, an image of calibration plate with a yellow pattern printed thereon in a state where a red calibration pattern is projected on the calibration plate from a projector, and calculating an internal parameter of the projector, based on the result of the image capture.

US 2008/0285843 is an example of the related art.

The internal parameter of the projector is used to calculate, for example, one or both of the position and the attitude of the projector in relation to the camera, as an external parameter of the projector. In the technique of US 2008/0285843, not only the projector and the camera but also the calibration plate need to be prepared when calculating the internal parameter, and this takes time and effort from the user.

### SUMMARY

According to an aspect of the present disclosure, a projection method includes: projecting a drawn image drawn on a display panel of a projector onto a projection surface from the projector as a projection image; picking up the projection image with a camera having a first internal parameter and thus acquiring a picked-up image; generating a first correspondence relationship in which a plurality of first coordinates which are coordinates of a plurality of first pixels forming the projection image in the picked-up image and a plurality of second coordinates which are coordinates of a plurality of second pixels forming the drawn image are associated with each other; acquiring state information indicating a state of an optical system of the projector; estimating a second internal parameter which is an internal parameter of the optical system, based on a second correspondence relationship in which the second internal parameter and the state of the optical system are associated with each other, and the state information; and estimating an external parameter indicating one or both of a position and an attitude of the projector in relation to the camera, based on the first internal parameter, the first correspondence relationship, and the second internal parameter.

According to another aspect of the present disclosure, a system includes a projector and a camera having a first internal parameter, and the projector executes: projecting a projection image onto a projection surface from the projector; picking up the projection image with the camera and thus acquiring a picked-up image; generating a first correspondence relationship in which a plurality of first coordinates which are coordinates of a plurality of first pixels forming the projection image in the picked-up image and a plurality of second coordinates which are coordinates of a plurality of second pixels forming the projection image on a display panel of the projector are associated with each other; acquiring state information indicating a state of an optical system of the projector; estimating a second internal parameter which is an internal parameter of the optical system, based on a second correspondence relationship in which the second internal parameter and the state of the optical system are associated with each other, and the state information; and estimating an external parameter indicating one or both of a position and an attitude of the projector in relation to the camera, based on the first internal parameter, the first correspondence relationship, and the second internal parameter.

According to still another aspect of the present disclosure, a non-transitory computer-readable storage medium storing a program is provided, the program causing a computer to execute: projecting a projection image onto a projection surface from a projector; picking up the projection image with a camera having a first internal parameter and thus acquiring a picked-up image; generating a first correspondence relationship in which a plurality of first coordinates which are coordinates of a plurality of first pixels forming the projection image in the picked-up image and a plurality of second coordinates which are coordinates of a plurality of second pixels forming the projection image on a display panel of the projector are associated with each other; acquiring state information indicating a state of an optical system of the projector; estimating a second internal parameter which is an internal parameter of the optical system, based on a second correspondence relationship in which the second internal parameter and the state of the optical system are associated with each other, and the state information; and estimating an external parameter indicating one or both of a position and an attitude of the projector in relation to the camera, based on the first internal parameter, the first correspondence relationship, and the second internal parameter.

### BRIEF DESCRIPTION OF THE DRAWINGS

FIG. 1 is a diagram illustrating an overview of a system used for a projection method according to a first embodiment.

FIG. 2 is a block diagram illustrating a projector used in the system according to the first embodiment.

FIG. 3 is a flowchart showing the flow of the projection method according to the first embodiment.

FIG. 4 is a flowchart showing the flow of measurement of the shape of a projection surface according to the first embodiment.

FIG. 5 is a diagram illustrating the relationship between coordinates of a projection image on a display panel and coordinates in a picked-up image.

FIG. 6 is a diagram illustrating an example of a second correspondence relationship.

FIG. 7 is a flowchart showing the flow of adjustment of the projection image.

FIG. 8 is a diagram illustrating a plurality of reference points of the projection image on the display panel.

FIG. 9 is a diagram illustrating three-dimensional coordinates of a marker at a first timing.

FIG. 10 is a flowchart illustrating the flow of restoration.

FIG. 11 is a diagram illustrating three-dimensional coordinates of the marker at a second timing.

FIG. 12 is a diagram illustrating three-dimensional coordinates of the marker at the first timing and the second timing.

FIG. 13 is a diagram illustrating adjustment of the projection image.

FIG. 14 is a diagram illustrating an overview of a system used for a projection method according to a second embodiment.

FIG. 15 is a block diagram illustrating a projector used in the system according to the second embodiment.

FIG. 16 is a flowchart illustrating the flow of measurement of the shape of a projection surface according to the second embodiment.

FIG. 17 is a diagram illustrating the shape measurement of a first part and a second part of the projection surface.

### DESCRIPTION OF EMBODIMENTS

Preferred embodiments according to the present disclosure will now be described with reference to the accompanying drawings. In the drawings that the dimension and scale of each part differ from actual values as appropriate, and some parts may be schematically shown in order to facilitate understanding. The scope of the present disclosure is not limited to the embodiments described below unless the description particularly states that limitations are applied to the present disclosure.

### 1. First Embodiment

### 1-1. Overview of System

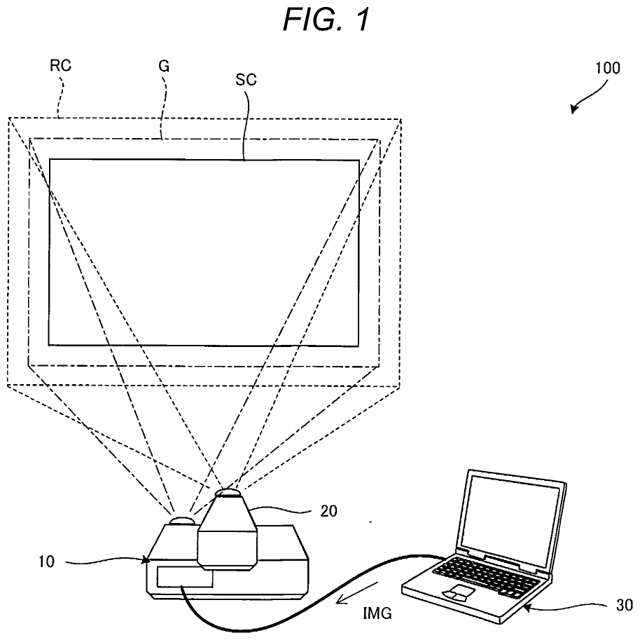

FIG. 1 is a diagram illustrating an overview of a system 100 used for a projection method according to a first embodiment. The system 100 is a projection system for projecting a projection image G onto a projection surface SC.

The projection surface SC is a surface of an object such as a screen. In the example shown in FIG. 1, the projection surface SC is a planar surface. The shape of the projection surface SC is not limited to the example illustrated in FIG. 1, and for example, the projection surface SC may be a surface having a part curved in a concave shape as in a second embodiment, described later, or a surface having a part curved in a convex shape.

As illustrated in FIG. 1, the system 100 includes a projector 10, a camera 20, and a terminal device 30.

The projector 10 is a display device that projects a projection image G represented by image data IMG output from the terminal device 30, onto the projection surface SC. In the example illustrated in FIG. 1, the projection image G is projected onto an area including the projection surface SC. The projection position of the projection image G in relation to the projection surface SC is not limited to the example illustrated in FIG. 1 and may be any position.

The projector 10 in the present embodiment has a function of controlling the operations of the camera 20 and a function of adjusting the shape of the projection image G, using a result of image pickup by the camera 20. The camera 20 is a digital camera having an image pickup device such as a charge-coupled device (CCD) or a complementary metal-oxide semiconductor (CMOS). The camera 20 picks up an image of an area RC. The area RC is an area including the projection image G projected on the projection surface SC. The camera 20 may be an element of the projector 10.

The terminal device 30 is a computer having a function of supplying the image data IMG to the projector 10. In the example shown in FIG. 1, the terminal device 30 is a laptop computer. Note that the terminal device 30 is not limited to a laptop computer and may be, for example, a desktop computer, a smartphone, or a tablet terminal or the like, or may be a video player, a digital versatile disk (DVD) player, a Blu-ray disc player, a hard disk recorder, a television tuner, a set-top box for cable television (CATV), a video game console, or the like.

### 1-2. Projector

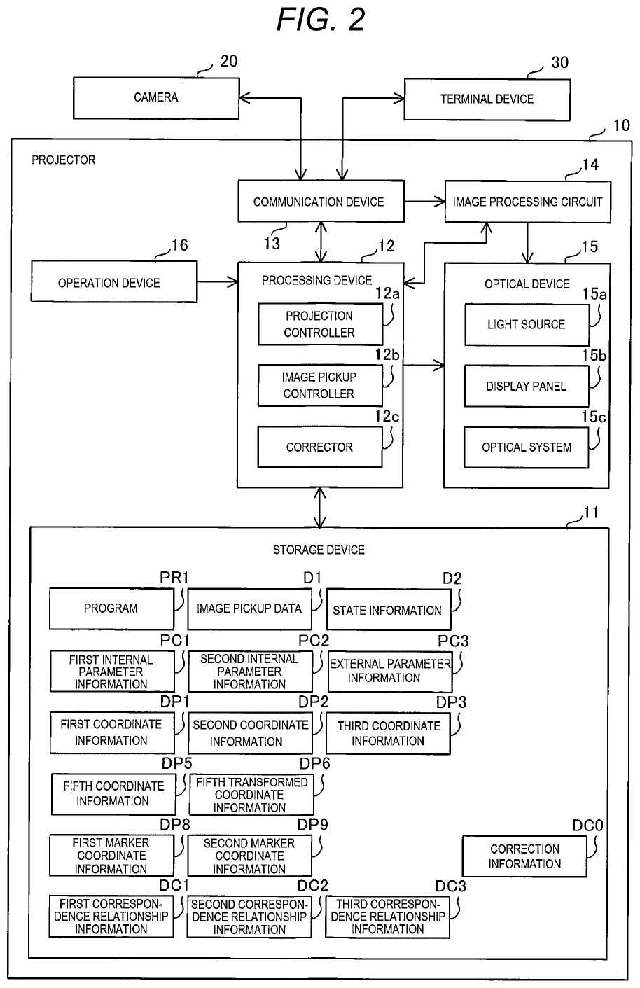

FIG. 2 is a block diagram illustrating the projector 10 used in the system 100 according to the first embodiment. FIG. 2 shows the coupling state of the camera 20 and the terminal device 30 to the projector 10 in addition to the illustration of the projector 10.

As shown in FIG. 2, the projector 10 includes a storage device 11, a processing device 12, a communication device 13, an image processing circuit 14, an optical device 15, and an operation device 16. These devices are communicably coupled to one another.

The storage device 11 is a storage device that stores a program to be executed by the processing device 12 and data to be processed by the processing device 12. The storage device 11 includes, for example, a hard disk drive or a semiconductor memory. A part or all of the storage device 11 may be provided in a storage device, a server, or the like outside the projector 10.

The storage device 11 stores a program PR1, image pickup data D1, state information D2, first internal parameter information PC1, second internal parameter information PC2, external parameter information PC3, first coordinate information DP1, second coordinate information DP2, third coordinate information DP3, fifth coordinate information DP5, fifth transformed coordinate information DP6, first marker coordinate information DP8, second marker coordinate information DP9, first correspondence relationship information DC1, second correspondence relationship information DC2, third correspondence relationship information DC3, and correction information DC0.

The program PR1 is a program for executing a projection method described in detail below.

The image pickup data D1 is information representing a picked-up image GG described below that is acquired by picking up the projection image G with the camera 20.

The state information D2 is information indicating the state of an optical system 15c of the projector 10. The state of the optical system 15c of the projector 10 is the state of optical characteristics such as optical distortion, amount of lens shift, and projection range (throw ratio), and is represented by, for example, information such as the number of steps of a motor driving the optical system 15c, an applied current or an applied voltage to the motor, and a detection value of a sensor detecting the position of a lens provided in the optical system 15c. The lens provided in the optical system 15c refers to a projection lens. The optical distortion varies from one amount of lens shift to another and therefore is mapped for each amount of lens shift.

The first internal parameter information PC1 is information indicating a first internal parameter of the camera 20. The first internal parameter is a known parameter representing an optical characteristic such as the optical center, the focal length, or the aberration of the camera 20. Hereinafter, the first internal parameter indicated by the first internal parameter information PC1 may be simply referred to as a “first internal parameter”.

The second internal parameter information PC2 is information indicating a second internal parameter, which is an internal parameter of the projector 10. The second internal parameter is a parameter representing an optical characteristic such as the angle of view or the optical center of the optical device 15 of the projector 10. The angle of view varies depending on the throw ratio or the optical zoom. The optical center varies depending on the lens offset or the lens shift. Hereinafter, the second internal parameter indicated by the second internal parameter information PC2 may be simply referred to as a “second internal parameter”.

The external parameter information PC3 is information indicating an external parameter indicating one or both of the position and the attitude of the projector 10 in relation to the camera 20. Hereinafter, the external parameter indicated by the external parameter information PC3 may be simply referred to as an “external parameter”.

The first coordinate information DP1 is information indicating a plurality of first coordinates, which are coordinates of a plurality of first pixels in the picked-up image GG described below that is represented by the image pickup data D1. The first pixel is a pixel of the camera 20. The first coordinates are coordinates of the first pixel in the coordinate system of the picked-up image GG described later that is acquired by the camera 20. The first coordinates are two-dimensional coordinates.

The second coordinate information DP2 is information indicating a plurality of second coordinates, which are coordinates of a plurality of second pixels on a display panel 15b of the projector 10. The second pixel is a pixel of the display panel 15b. The second coordinates are coordinates of the second pixel in the coordinate system of the display panel 15b. The second coordinates are two-dimensional coordinates. A drawn image based on the image data IMG is drawn on the display panel 15b, and the drawn image is projected as the projection image G via the projection lens. The pixels forming the drawn image are the second pixels.

The third coordinate information DP3 indicates a plurality of third coordinates, which are three-dimensional coordinates of the projection image G on the projection surface SC. In this specification, the three-dimensional coordinates on the projection surface SC are coordinates in a world coordinate system, which is a three-dimensional coordinate system set in a real space where the projection surface SC is installed or a virtual three-dimensional space corresponding to the real space. In the description below, the three-dimensional coordinate system may be simply referred to as a “three-dimensional coordinate system”. The three-dimensional coordinates may be simply referred to as “three-dimensional coordinates”.

The fifth coordinate information DP5 is information indicating a plurality of fifth coordinates, which are coordinates of a plurality of reference points PR, described later, of the projection image G on the display panel 15b of the projector 10. The fifth coordinates are coordinates of a pixel corresponding to a reference point PR, described later, in the coordinate system of the display panel 15b.

The fifth transformed coordinate information DP6 is information indicating coordinates obtained by transforming the plurality of fifth coordinates indicated by the fifth coordinate information DP5 into three-dimensional coordinates.

The first marker coordinate information DP8 is information indicating three-dimensional coordinates of a marker MK, described later, at a first timing.

The second marker coordinate information DP9 is information indicating three-dimensional coordinates of the marker MK, described later, at a second timing later than the first timing.

The first correspondence relationship information DC1 is information indicating a first correspondence relationship in which the plurality of first coordinates indicated by the first coordinate information DP1 and the plurality of second coordinates indicated by the second coordinate information DP2 are associated with each other. That is, the first correspondence relationship indicated by the first correspondence relationship information DC1 is the correspondence relationship between the coordinate system of the picked-up image GG, described later, that is acquired by the camera 20, and the coordinate system of the display panel 15b of the projector 10. The first correspondence relationship is the correspondence relationship between a plurality of first coordinates, which are coordinates of a plurality of first pixels forming the projection image G in the picked-up image GG, and a plurality of second coordinates, which are coordinates of a plurality of second pixels forming the drawn image. Hereinafter, the first correspondence relationship indicated by the first correspondence relationship information DC1 may be simply referred to as a “first correspondence relationship”.

The second correspondence relationship information DC2 is information indicating a second correspondence relationship in which the second internal parameter, which is the internal parameter of the optical system 15c, and the state of the optical system 15c are associated with each other. The second correspondence relationship information DC2 includes information indicating the second correspondence relationship for each temperature of the optical system 15c. Hereinafter, the second correspondence relationship indicated by the second correspondence relationship information DC2 may be simply referred to as a “second correspondence relationship”. The second correspondence relationship information DC2 is acquired using a result of calculating the second correspondence relationship by an experiment or the like, and is stored in the storage device 11 in advance.

The third correspondence relationship information DC3 is information indicating a third correspondence relationship in which the plurality of first coordinates indicated by the first coordinate information DP1 and the plurality of third coordinates indicated by the third coordinate information DP3 are associated with each other. That is, the third correspondence relationship indicated by the third correspondence relationship information DC3 is the correspondence relationship between the coordinate system of the picked-up image GG, described later, that is acquired by the camera 20, and the three-dimensional coordinate system. Hereinafter, the third correspondence relationship indicated by the third correspondence relationship information DC3 may be simply referred to as a “third correspondence relationship”.

The correction information DC0 is information indicating a correspondence relationship in which the plurality of second coordinates indicated by the second coordinate information DP2 and the plurality of third coordinates indicated by the third coordinate information DP3 are associated with each other. That is, the correspondence relationship indicated by the correction information DC0 is the correspondence relationship between the three-dimensional coordinate system and the coordinate system of the display panel 15b of the projector 10.

The processing device 12 is a processing device having a function of controlling each part of the projector 10 and a function of processing various kinds of data. For example, the processing device 12 includes a processor such as a central processing unit (CPU). The processing device 12 may be configured with a single processor or may be configured with a plurality of processors. A part or all of the functions of the processing device 12 may be implemented by hardware such as a digital signal processor (DSP), an application-specific integrated circuit (ASIC), a programmable logic device (PLD), or a field-programmable gate array (FPGA). The processing device 12 may be integrated with at least a part of the image processing circuit 14.

The communication device 13 is a communication device that can communicate with various devices, and acquires the video data IMG from the terminal device 30 and communicates with the camera 20. For example, the communication device 13 is a wired communication device such as a wired local area network (LAN), a universal serial bus (USB), and a high-definition multimedia interface (HDMI), or a wireless communication device such as a low power wide area (LPWA), wireless LAN including Wi-Fi, and a Bluetooth device. Each of “HDMI”, “Wi-Fi”, and “Bluetooth” is a registered trademark.

The image processing circuit 14 is a circuit that performs necessary processing on the image data IMG from the communication device 13 and inputs the data to the optical device 15. The image processing circuit 14 has, for example, a frame memory, not illustrated, loads the image data IMG in the frame memory, executes various kinds of processing such as resolution conversion processing, resizing processing, and distortion correction processing, as appropriate, and inputs the data to the optical device 15. The above-described correction information DC0 is used in the various kinds of processing as appropriate. The image processing circuit 14 may execute processing such as on-screen display (OSD) processing of generating image information for showing a menu, operation guidance, or the like, and combining the information with the image data IMG, according to need.

The optical device 15 is a device that projects image light on the projection surface SC. The optical device 15 includes a light source 15a, the display panel 15b, and the optical system 15c.

The light source 15a includes, for example, light sources such as halogen lamps, xenon lamps, ultra-high-pressure mercury lamps, light-emitting diodes (LEDs), or laser light sources, which respectively emit red, green, and blue lights. The display panel 15b is a light modulator including three light modulation elements provided corresponding to red, green, and blue. The light modulation elements include, for example, transmissive liquid crystal panels, reflective liquid crystal panels, or digital mirror devices (DMDs) or the like, and modulate corresponding color lights to generate image lights of the respective colors. The image lights of the respective colors generated by the display panel 15b are combined together by a light combining system into a full-color image light. The optical system 15c is a projection system including a projection lens or the like that forms an image of the full-color image light from the display panel 15b and projects the image on the projection surface SC.

The operation device 16 is an device that accepts an operation from the user. For example, the operation device 16 includes an operation panel and a remote control light receiver, not illustrated. The operation panel is provided in an exterior casing of the projector 10 and outputs a signal based on an operation by the user. The remote control light receiver receives an infrared signal from a remote controller, not illustrated, decodes the infrared signal, and outputs a signal based on the operation of the remote controller. The operation device 16 is provided according to need and may be omitted.

In the above-described projector 10, the processing device 12 executes the program PR1 stored in the storage device 11 and thus functions as a projection controller 12a, an image pickup controller 12b, and a corrector 12c. Therefore, the processing device 12 includes the projection controller 12a, the image pickup controller 12b, and the corrector 12c.

The projection controller 12a controls operations of the image processing circuit 14 and the optical device 15. More specifically, the projection controller 12a controls the operation of the optical device 15 to project the projection image G onto the projection surface SC.

The image pickup controller 12b controls operations of the camera 20. More specifically, the image pickup controller 12b causes the camera 20 to pick up the projection image G projected on the projection surface SC, thus acquires the image pickup data D1, and stores the acquired image pickup data D1 in the storage device 11.

The corrector 12c performs a correction to adjust the shape of the projection image G.

More specifically, the corrector 12c generates the first coordinate information DP1 and the second coordinate information DP2, based on the image pickup data D1, generates the first correspondence relationship information DC1, based on the first coordinate information DP1 and the second coordinate information DP2, and stores the generated first correspondence relationship information DC1 in the storage device 11.

The corrector 12c acquires the state information D2, generates the second internal parameter information PC2, based on the second correspondence relationship information DC2 and the state information D2, and stores the generated second internal parameter information PC2 in the storage device 11. For example, the corrector 12c monitors, for example, the state of the optical characteristics such as the optical distortion, the amount of lens shift, and the projection range (throw ratio) of the optical system 15c, and updates the state information D2 when the state is changed. When information related to the state information D2 is stored in the storage device 11 separately from the state information D2 or in another storage device 11, or when a sensor for detecting the state of the optical system 15c is provided, the corrector 12c may update the state information D2 at the time of execution of step S104, described later.

Also, the corrector 12c generates the external parameter information PC3, based on the first internal parameter information PC1, the first correspondence relationship information DC1, and the second internal parameter information PC2, and causes the storage device 11 to store the generated external parameter information PC3. The corrector 12c estimates the external parameter, using the second correspondence relationship corresponding to the temperature of the optical system 15c.

Also, the corrector 12c generates the third coordinate information DP3, based on the first internal parameter information PC1, the second internal parameter information PC2, the first correspondence relationship information DC1, and the external parameter information PC3, and causes the storage device 11 to store the generated third coordinate information DP3.

Moreover, the corrector 12c generates the third correspondence relationship information DC3, based on the first coordinate information DP1 and the third coordinate information DP3, and causes the storage device 11 to store the generated third correspondence relationship information DC3.

Also, the corrector 12c generates the correction information DC0, based on the first correspondence relationship information DC1 and the third correspondence relationship information DC3, and causes the storage device 11 to store the generated correction information DC0.

Moreover, when the optical system 15c of the projector 10 is adjusted, the corrector 12c updates one or both of the second internal parameter information PC2 and the external parameter information PC3, based on the result of capturing, with the camera 20, the projection image G projected after the optical system 15c is adjusted.

Also, the corrector 12c generates the fifth coordinate information DP5, based on the plurality of reference points PR, described later, in the projection image G, and causes the storage device 11 to store the generated fifth coordinate information DP5.

Moreover, the corrector 12c transforms the fifth coordinate information DP5, using the correction information DC0, thus generates the fifth transformed coordinate information DP6, and causes the storage device 11 to store the generated fifth transformed coordinate information DP6.

Also, the corrector 12c generates the first marker coordinate information DP8, based on the fifth coordinate information DP5 and the third correspondence relationship information DC3, and causes the storage device 11 to store the generated first marker coordinate information DP8.

Moreover, the corrector 12c generates the second marker coordinate information DP9, based on the fifth transformed coordinate information DP6 and the third correspondence relationship information DC3, and causes the storage device 11 to store the generated second marker coordinate information DP9.

The corrector 12c adjusts the projection image G, based on the first marker coordinate information DP8, the second marker coordinate information DP9, the fifth transformed coordinate information DP6, the second internal parameter information PC2, and the external parameter information PC3. The corrector 12c generates the fifth coordinate information DP5, based on the result of accepting, from the user, an operation of moving the plurality of reference points PR, described later, in order to adjust the shape of the projection image G.

### 1-3. Control Method

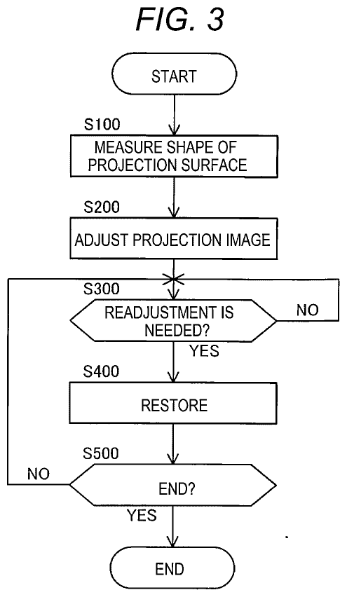

FIG. 3 is a flowchart showing the flow of the projection method according to the first embodiment. The projection method is performed by the processing device 12, which is an example of a “computer”, executing the program PR1 using the system 100 including the projector 10 and the camera 20 described above. As shown in FIG. 3, the projection method includes steps S100 to S500.

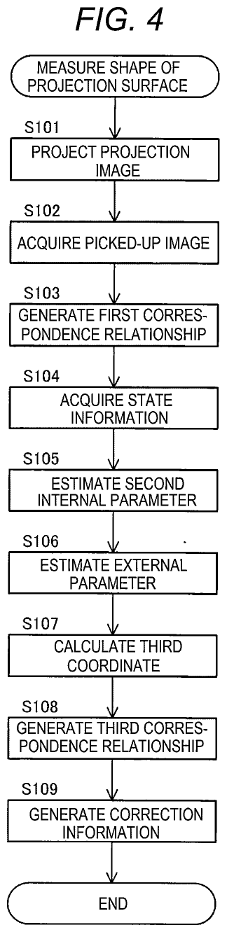

Specifically, first, in step S100, the shape of the projection surface SC is measured. Details of step S100 will be described later with reference to FIGS. 4 to 6.

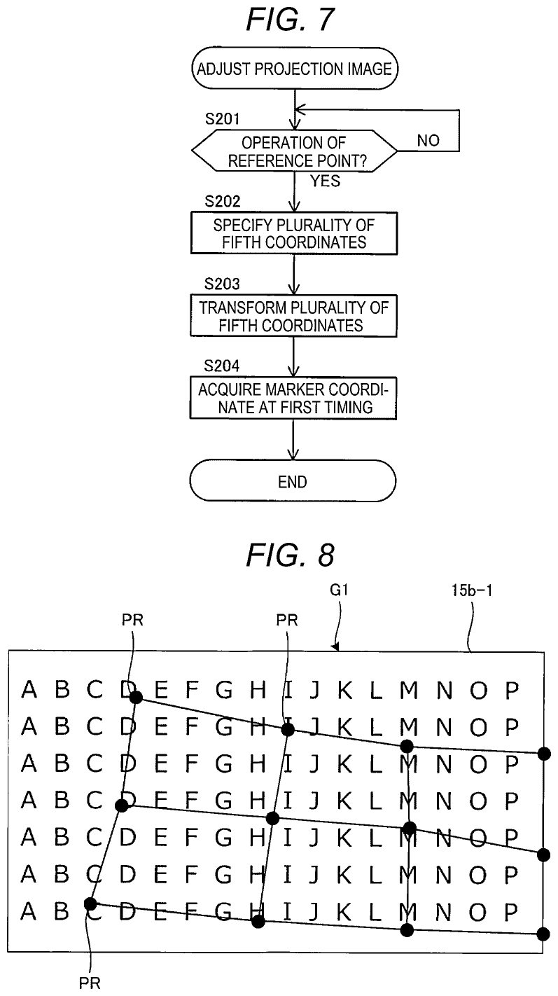

After step S100, the projection image G is adjusted in step S200. By this adjustment, the fifth coordinate information DP5, the fifth transformed coordinate information DP6, and the first marker coordinate information DP8 are acquired. Details of the acquisition will be described later with reference to FIGS. 7 to 9.

Then, in step S300, whether the projection image G needs to be readjusted is determined. For example, when the amount of change in the positional relationship of the projector 10 in relation to the projection surface SC is equal to or greater than a predetermined amount, it is determined that the projection image G needs to be readjusted. It may be determined that the projection image G needs to be readjusted, based on an instruction from the user, or it may be determined that the projection image G needs to be readjusted, based on an output of a sensor or the like that detects the amount of change in the positional relationship of the projector 10 in relation to the projection surface SC.

Step S300 is repeated until it is determined that the projection image G needs to be readjusted (NO in step S300), and when it is determined that the projection image G needs to be readjusted (YES in step S300), in step S400, the projection image G is readjusted and the projection state of the projection image G in relation to the projection surface SC is thus restored from the state at the second timing to the state at the first timing. Details of this restoration will be described below with reference to FIGS. 10 to 13.

After step S400, whether an instruction to end is given is determined in step S500. This determination is made, for example, based on whether an instruction to end based on an operation from the user is given.

When an instruction to end is not given (NO in step S500), the foregoing step S300 is executed. Thus, the foregoing steps S300 and S400 are repeated until an instruction to end is given. Meanwhile, when an instruction to end is given (YES in step S500), the processing is ended.

FIG. 4 is a flowchart showing the flow of the measurement of the shape of the projection surface SC in the first embodiment. Step S100 shown in FIG. 3 includes steps S101 to S109 as shown in FIG. 4.

Specifically, in step S101, the projection image G is projected from the projector 10 onto the projection surface SC. This projection is performed by the projection controller 12a controlling the operation of the projector 10.

In step S102, the projection image G is picked up by the camera 20 and the picked-up image GG, described later, is thus acquired. The acquisition is performed by the image pickup controller 12b controlling the operation of the camera 20. The acquired picked-up image GG is stored in the storage device 11 as the image pickup data D1.

In step S103, the first correspondence relationship is generated. This generation is performed by the corrector 12c associating the plurality of first coordinates, which are the coordinates of the plurality of first pixels forming the projection image G in the picked-up image GG, described later, with the plurality of second coordinates, which are the coordinates of the plurality of second pixels forming the projection image G on the display panel 15b of the projector 10. The generated first correspondence relationship is stored in the storage device 11 as the first correspondence relationship information DC1.

In step S104, the state information D2 is acquired. This acquisition is performed by the corrector 12c detecting the state of the optical system 15c. The acquired state information D2 is stored in the storage device 11.

In step S105, the second internal parameter is estimated. This estimation is performed by the corrector 12c, based on the second correspondence relationship and the state information D2. The estimated second internal parameter is stored in the storage device 11 as the second internal parameter information PC2.

In step S106, the external parameter indicating one or both of the position and the attitude of the projector 10 in relation to the camera 20 is estimated. This estimation is performed by the corrector 12c, based on the first internal parameter, the first correspondence relationship, and the second internal parameter. The estimated external parameter is stored in the storage device 11 as the external parameter information PC3.

In step S107, a plurality of third coordinates, which are three-dimensional coordinates of the projection image G in the projection surface SC, are calculated. The plurality of third coordinates are calculated by the corrector 12c, based on the first internal parameter, the second internal parameter, the first correspondence relationship, and the external parameter. The plurality of third coordinates, thus calculated, are stored in the storage device 11 as the third coordinate information DP3.

In step S108, the third correspondence relationship is generated. This generation is performed by the corrector 12c associating the plurality of first coordinates with the plurality of third coordinates. The generated third correspondence relationship is stored in the storage device 11 as the third correspondence relationship information DC3.

In step S109, a correspondence relationship in which the plurality of second coordinates indicated by the second coordinate information DP2 and the plurality of third coordinates indicated by the third coordinate information DP3 are associated is generated. This generation is performed by the corrector 12c, based on the first correspondence relationship indicated by the first correspondence relationship information DC1 and the third correspondence relationship indicated by the third correspondence relationship information DC3. The generated correspondence relationship is stored in the storage device 11 as the correction information DC0.

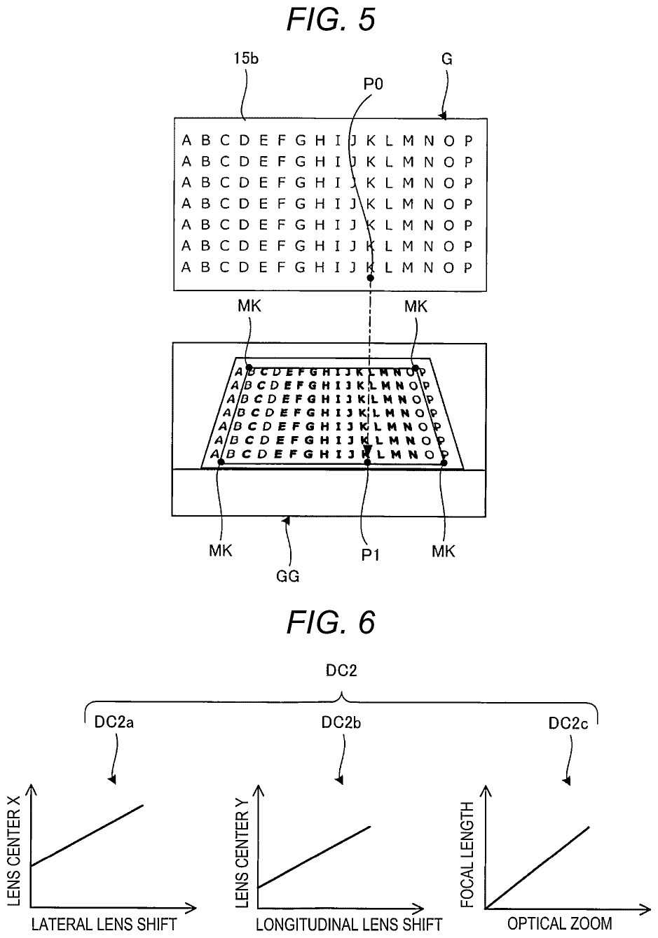

Steps S101 to S110 in the above overview will now be described in detail with reference to FIGS. 5 and 6.

FIG. 5 is a diagram illustrating the relationship between the coordinates of the projection image G on the display panel 15b and the coordinates in the picked-up image GG. FIG. 5 illustrates the correspondence relationship between a first pixel P1, which is a pixel of the picked-up image GG indicated by the image pickup data D1, and a second pixel P0, which is a pixel on the display panel 15b displaying the projection image G.

In step S101, the projection image G is projected onto the projection surface SC. At this time, as illustrated at the top of FIG. 5, the projection image G is displayed on the display panel 15b. In the example illustrated in FIG. 5, the projection image G is an image in which a plurality of alphabets are arrayed. The projection image G is an image for detecting the correspondence of the first pixel P1 in relation to the second pixel P0 and is not limited to the example illustrated in FIG. 5 and may be a phase shift pattern, a gray code pattern, a pattern image, or the like.

In step S102, the camera 20 picks up the projection image G projected onto the projection surface SC, and the picked-up image GG represented by the image pickup data D1 is thus acquired, as illustrated at the bottom of FIG. 5. In the picked-up image GG, a plurality of markers MK, described later, are captured in addition to the projection surface SC and the projection image G.

In step S103, first, the first coordinate information DP1 is generated, based on are plurality of first coordinates, which are the coordinates of a plurality of first pixels P1 in the coordinate system of the picked-up image GG, and the second coordinate information DP2 is generated, based on a plurality of second coordinates, which are the coordinates of a plurality of second pixels on the display panel 15b. In step S103, based on the first coordinate information DP1 and the second coordinate information DP2, the first correspondence relationship information indicating the first correspondence relationship in which the plurality of first coordinates and the plurality of second coordinates are associated with each other is generated.

The plurality of first pixels P1 and the plurality of second pixels P0 correspond to each other. Such a correspondence between the plurality of first pixels P1 and the plurality of second pixels P0 is detected by a known measurement method. In FIG. 5, for the sake of convenience of description, one first pixel P1 and one second pixel P0 are illustrated.

In step S104, the corrector 12c reads and acquires the state information D2 from the storage device 11. In step S105, the corrector 12c estimates the second internal parameter indicated by the second internal parameter information PC2, based on the second correspondence relationship indicated by the second correspondence relationship information DC2 and the state information D2.

FIG. 6 is a diagram illustrating an example of the second correspondence relationship indicated by the second correspondence relationship information DC2. In the example illustrated in FIG. 6, the second correspondence relationship information DC2 includes information DC2a, DC2b, and DC2c.

As shown on the left side in FIG. 6, the information DC2a is information indicating the relationship between the amount of lens shift in the lateral direction of the optical system 15c and the position of the lens center. Therefore, based on the amount of lens shift in the lateral direction indicated by the state information D2 and the relationship indicated by the information DC2a, the position of the lens center in the lateral direction of the optical system 15c can be estimated.

As shown at the center in FIG. 6, the information DC2b is information indicating the relationship between the amount of lens shift in the longitudinal direction of the optical system 15c and the position of the lens center. Therefore, based on the amount of lens shift in the longitudinal direction indicated by the state information D2 and the relationship indicated by the information DC2b, the position of the lens center in the longitudinal direction of the optical system 15c can be estimated.

As shown on the right side of FIG. 6, the information DC2c is information indicating the relationship between the amount of optical zoom and the focal length of the optical system 15c. Therefore, based on with the amount of optical zoon indicated by the state information D2 and the relationship indicated by the information DC2c, the focal length of the optical system 15c can be estimated.

The optical characteristics of the optical system 15c vary depending on the temperature of the optical system 15c. For example, a plurality of information DC2a, DC2b, and DC2c may be provided for each predetermined temperature range. When a plurality of sets of information DC2a, DC2b, and DC2c are provided for each predetermined temperature range, the corrector 12c selects and uses one set of information DC2a, DC2b, and DC2c from the plurality of sets of information DC2a, DC2b, and DC2c, based on the result of detection by a temperature sensor, not illustrated.

The information DC2a, DC2b, and DC2c may be in the form of a function such as a linear function, or may be in the form of a lookup table. The information DC2a, DC2b, and DC2c are not limited to the example illustrated in FIG. 6, and may include, for example, information about optical distortion.

As described above, in step S105, the second internal parameter indicated by the second internal parameter information PC2 is estimated, using the state information D2. The final result of estimation in step S105 may be the result of estimating the second internal parameter, using the state information D2, or may be a value optimized by processing such as reprojection error minimization using the estimated value as an initial value.

In step S106, the external parameter indicating one or both of the position and the attitude of the projector 10 in relation to the camera 20 is estimated, based on the first internal parameter, the first correspondence relationship, and the second internal parameter, using the coordinate system of the picked-up image GG, described later, that is acquired from the camera 20, as reference coordinates. For this estimation, a known technique such as a five-point algorithm such as OpenCV is used. The position is represented by, for example, a three-dimensional vector (tx, ty, tz). The attitude is represented by, for example, a three-dimensional vector (rx, ry, rz) or a 3×3 rotation matrix.

In the camera 20, when coordinates in an image sensor are represented as (u, v) and normalized coordinates calculated by normalizing the foregoing coordinates with a focal length f of the camera are represented as (x, y), these coordinates have a relationship expressed by the following equation.

$$( \begin{matrix}u \\ v \\ 1\end{matrix} ) = ( \begin{matrix}f & 0 & {c}_{u} \\ 0 & f & {c}_{v} \\ 0 & 0 & 1\end{matrix} ) ( \begin{matrix}x \\ y \\ 1\end{matrix} ) = A ( \begin{matrix}x \\ y \\ 1\end{matrix} )$$

In the above equation, (cᵤ, cᵥ) is an optical center coordinates of the camera. The internal parameter of the camera 20 is represented by an internal parameter matrix A, which is the product of the optical center coordinates (cᵤ, cᵥ) and the focal length f. The internal parameter of the camera 20 may be calculated by multiplying the internal parameter matrix A by another parameter such as a lens distortion coefficient.

In step S107, a plurality of three-dimensional coordinates on the projection surface SC are calculated by triangulation between the projection surface SC, the camera 20, and the projector 10, using the second internal parameter information PC2, the external parameter information PC3, and the first correspondence relationship information DC1 that are already acquired. The plurality of third coordinates calculated by such triangulation are acquired as the third coordinate information DP3.

After the third coordinate information DP3 is acquired in step S107 in this way, in step S108, the third correspondence relationship information DC3 indicating the third correspondence relationship in which the plurality of first coordinates and the plurality of third coordinates are associated with each other is generated, based on the first coordinate information DP1 and the third coordinate information DP3.

After the third correspondence relationship information DC3 is acquired in step S108 in this way, in step S109, the correction information DC0 indicating the correspondence relationship in which the plurality of second coordinates and the plurality of third coordinates are associated is generated, based on the third correspondence relationship information DC3 and the first correspondence relationship information DC1.

FIG. 7 is a flowchart illustrating the flow of the adjustment of the projection image G. Step S200 shown in FIG. 3 includes steps S201 to S204 as shown in FIG. 7.

Specifically, in step S200, first, in step S201, whether an operation on the plurality of reference points PR, described later, in the projection image G is performed is determined. This determination is performed by the corrector 12c, based on whether an operation by the user for moving the plurality of reference points PR is accepted. When the operation is accepted, it is determined that an operation on the plurality of reference points PR in the projection image G is performed. In this way, in step S201, the operation of moving the plurality of reference points PR in order to adjust the shape of the projection image G is accepted from the user.

Step S201 is repeated until the operation on the plurality of reference points PR in the projection image G is performed (NO in step S201) and, when the operation on the plurality of reference points PR in the projection image G is performed (YES in step S201), in step S202, a plurality of fifth coordinates, which are the coordinates of the plurality of reference points PR on the display panel 15b, are specified. The plurality of fifth coordinates are stored in the storage device 11 as the fifth coordinate information DP5. In this way, in step S202, the plurality of fifth coordinates are specified after the operation of moving the plurality of reference points PR in order to adjust the shape of the projection image G.

After step S202, in step S203, the plurality of fifth coordinates indicated by the fifth coordinate information DP5 are transformed into three-dimensional coordinates. This transformation is performed by the corrector 12c using the correspondence relationship indicated by the correction information DC0. By this conversion, the fifth transformed coordinate information DP6 is generated and the generated fifth transformed coordinate information DP6 is stored in the storage device 11.

After step S203, in step S204, three-dimensional coordinates of the marker MK, described later, that is set on the projection surface SC are acquired. This acquisition is performed by transforming the coordinates of the marker MK in the picked-up image GG into three-dimensional coordinates, using the third correspondence relationship indicated by the third correspondence relationship information DC3. The acquired third three-dimensional coordinate is stored in the storage device 11 as the first marker coordinate information DP8.

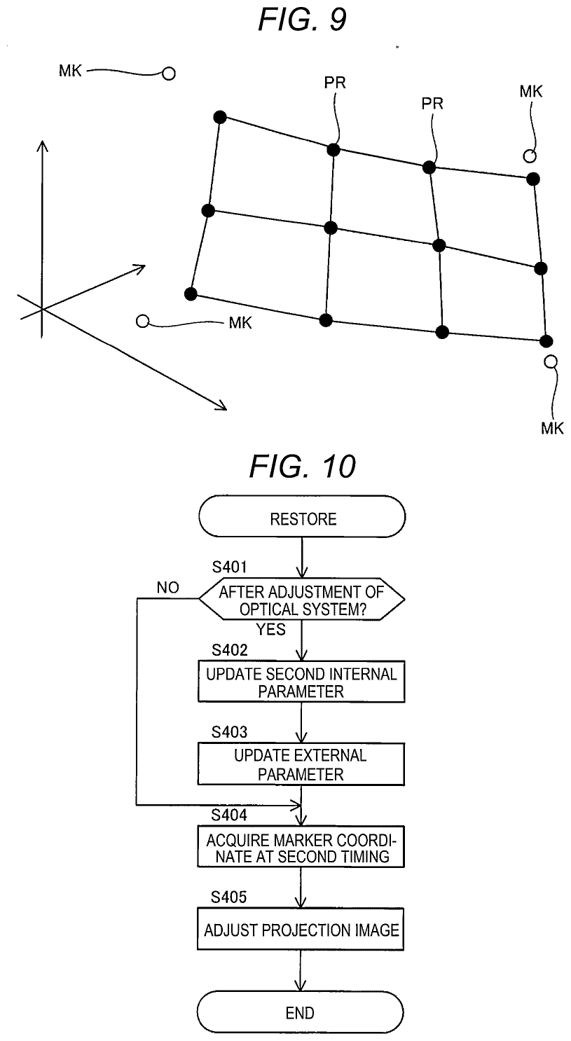

Steps S201 to S204 in the above overview will now be described in detail with reference to FIGS. 8 and 9.

FIG. 8 is a diagram illustrating the plurality of reference points PR on the display panel 15b of the projection image G. FIG. 8 illustrates a form in which the plurality of reference points PR are arranged in a grid pattern on the display panel 15b. In the example illustrated in FIG. 8, the plurality of reference points PR include a plurality of reference points PR arranged along a part corresponding to the outer edge of the projection surface SC on the display panel 15b. The arrangement and the number of the reference points PR on the display panel 15b are not limited to the example illustrated in FIG. 8 and may be freely set.

Each reference point PR can be moved by an operation by the user according to need. When two or more reference points PR selected by the user from among the plurality of reference points PR are moved, as the interval between the plurality of reference points PR changes, a part corresponding to the interval, of the projection image G, is deformed. Thus, the shape of the projection image G can be adjusted to fit the shape of the projection surface SC.

In step S201, whether such an operation is performed is determined. After step S201, in step S202, the fifth coordinate information DP5 indicating the plurality of fifth coordinates, which are the coordinates of the plurality of reference points PR on the display panel 15b, is acquired.

After step S202, in step S203, the fifth coordinate information DP5 is transformed, using the correspondence relationship indicated by the correction information DC0, and the fifth transformed coordinate information DP6 is thus generated.

FIG. 9 is a diagram illustrating the three-dimensional coordinates of the marker MK at the first timing. FIG. 9 illustrates the plurality of reference points PR explained above and a plurality of markers MK detected based on the picked-up image GG in a three-dimensional coordinate system set in a real space where the projection surface SC is installed or in a virtual three-dimensional space corresponding to the real space.

The plurality of markers MK are marks set at any positions on the projection surface SC. The shape, the position, and the number of the markers MK on the projection surface SC are not limited to the example illustrated in FIG. 9 and may be freely set. However, when the shape of the markers MK is not a shape that enables the determination of the attitude of the projection surface SC, the markers MK are set at any three or more positions on the projection surface SC.

In step S204, after the coordinates of the marker MK in the picked-up image GG are detected using a known technique such as a phase shift method or an image recognition technique, the coordinates are transformed using the third correspondence relationship information DC3, and the first marker coordinate information DP8 indicating the three-dimensional coordinates of the marker MK at the first timing is thus generated.

FIG. 10 is a flowchart illustrating the flow of the restoration. Step S400 show in FIG. 3 includes steps S401 to S405 as shown in FIG. 10.

Specifically, first, in step S401, whether an adjustment of the optical system 15c is performed is determined. This determination is performed by the corrector 12c, based on whether an adjustment such as a lens shift of the optical system 15c is performed. When an adjustment such as a lens shift of the optical system 15c is performed, it is determined that an adjustment of the optical system 15c is performed.

When the adjustment of the optical system 15c is performed (YES in step S401), the second internal parameter indicated by the second internal parameter information PC2 is updated in step S402. This update is performed by executing the foregoing step S105 again, using the result of capturing, with the camera 20, the projection image G projected after the adjustment of the optical system 15c. Thus, when the optical system 15c of the projector 10 is adjusted, the second internal parameter indicated by the second internal parameter information PC2 is updated, based on the result of capturing, with the camera 20, the projection image G projected after the adjustment of the optical system 15c. The updated second internal parameter is stored in the storage device 11 as the second internal parameter information PC2.

After step S402, the external parameter indicated by the external parameter information PC3 is updated. This update is performed by executing the foregoing step S106 again, using the result of capturing, the camera 20, the projection image G projected after the adjustment of the optical system 15c. Thus, when the optical system 15c of the projector 10 is adjusted, the external parameter indicated by the external parameter information PC3 is updated, based on the result of capturing, with the camera 20, the projection image G projected after the adjustment of the optical system 15c. The updated external parameter is stored in the storage device 11 as the external parameter information PC3.

After step S403 or when the adjustment of the optical system 15c is not performed (NO in step S401), in step S404, the three-dimensional coordinates of the marker MK at the second timing later than the first timing are acquired. This acquisition is performed by the corrector 12c performing processing similar to the foregoing step S204, based on a picked-up image formed by picking up an image of the projection surface SC with the camera 20 again. The acquired three-dimensional coordinates are stored in the storage device 11 as the second marker coordinate information DP9.

After step S404, the projection image G is adjusted in step S405. This adjustment is performed by the corrector 12c, based on the three-dimensional coordinates of the marker MK at the first timing, the three-dimensional coordinates of the marker MK at the second timing, the coordinates formed by transforming the plurality of fifth coordinates indicated by the fifth coordinate information DP5 into the three-dimensional coordinates, the first internal parameter indicated by the first internal parameter information PC1, the second internal parameter indicated by the second internal parameter information PC2, and the external parameter indicated by the external parameter information PC3.

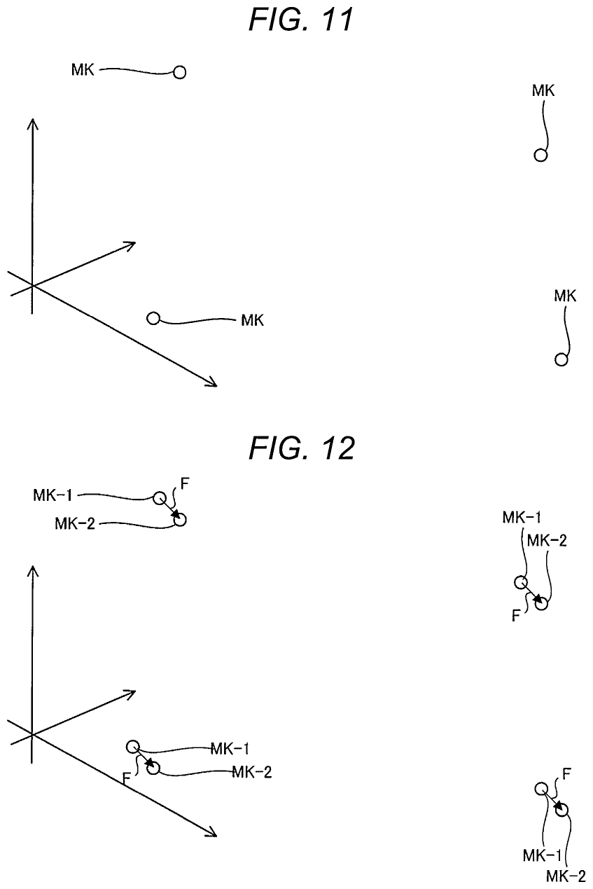

Step S405, of the above steps S401 to S405, will now be described in detail with reference to FIGS. 11 to 13.

FIG. 11 is a diagram illustrating the three-dimensional coordinates of the marker MK at the second timing. FIG. 11 illustrates a plurality of markers MK detected based on the result of image pickup in step S404 in a three-dimensional coordinate system set in a real space where the projection surface SC is installed or a virtual three-dimensional space corresponding to the real space.

FIG. 12 is a diagram illustrating the three-dimensional coordinates of the marker MK at the first timing and the second timing. In FIG. 12, in a three-dimensional coordinate system set in a real space where the projection surface SC is installed or a virtual three-dimensional space corresponding to the real space, a plurality of markers MK detected based on the picked-up image GG are indicated as markers MK-1 and a plurality of markers MK detected based on the result of image pickup in step S404 are indicated as markers MK-2.

In step S405, first, a function F representing a change in the position and the attitude of the projection surface SC from the first timing to the second timing is calculated, based on the coordinates of the plurality of markers MK-1 and the coordinates of the plurality of markers MK-2. The function F is a function representing three-dimensional affine transformation including three-dimensional translation, three-dimensional rotation, and scale transform.

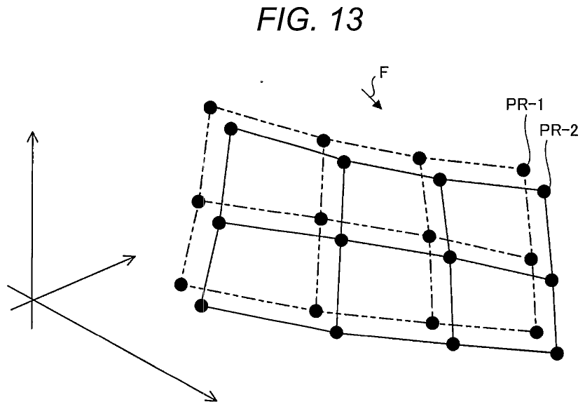

FIG. 13 is a diagram illustrating the adjustment of the projection image G. In FIG. 13, in a three-dimensional coordinate system set in a real space where the projection surface SC is installed or a virtual three-dimensional space corresponding to the real space, a plurality of reference points PR at the first timing are indicated as a plurality of reference points PR-1, and a plurality of reference points PR at the second timing are indicated as a plurality of reference points PR-2.

In step S405, as described above, after the function F representing the change in the position and the attitude of the projection surface SC from the first timing to the second timing is calculated, the transformation from the plurality of reference points PR-1 to the plurality of reference points PR-2 is performed by using the function F. Thus, the projection image G is adjusted.

The above-described projection method includes steps S101 to S106. Thus, the external parameter is estimated, using the second internal parameter estimated based on the second correspondence relationship and the state information D2, and therefore a calibration plate for estimating the external parameter need not be prepared. Therefore, a projection method that can save time and effort of the user can be provided.

As described above, the projection method according to the present embodiment includes step S107 and step S108. Thus, the third correspondence relationship that is necessary for various controls can be generated, using the second correspondence relationship.

Also, as described above, the external parameter is estimated, using the second correspondence relationship in accordance with the temperature of the optical system 15c. Thus, the external parameter can be suitably adjusted in accordance with the change in the optical characteristics due to the change in the temperature of the optical system 15c.

Moreover, as described above, the projection method according to the present embodiment includes steps S402 and S403. Thus, the external parameter can be updated in accordance with the change in the state of the optical system 15c of the projector 10.

Also, as described above, the projection method according to the present embodiment includes steps S202 to S204, steps S404 and S405. Thus, even when the projection image G at the second timing is displaced in relation to the projection image G at the first timing on the projection surface SC, the projection image G can be returned to the state of the projection image G at the first timing.

### 2. Second Embodiment

A second embodiment of the present disclosure will now be described. In the embodiment described below, elements having effects and functions similar to those in the first embodiment are denoted by the same reference numerals used in the first embodiment, and the detailed description thereof will be omitted as appropriate.

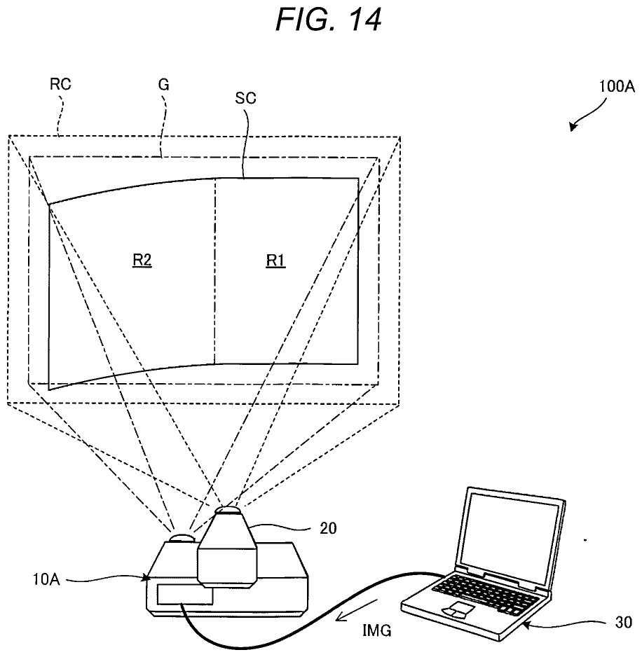

FIG. 14 is a diagram illustrating an overview of a system 100A used for a projection method according to the second embodiment. The system 100A has a configuration similar to the system 100 in the first embodiment except that a projector 10A is provided instead of the projector 10 in the first embodiment.

In the present embodiment, as illustrated in FIG. 14, the projection surface SC includes a first part R1 that is a planar surface and a second part R2 that is a concave curved surface. In the example illustrated in FIG. 14, the projection surface SC is divided into the first part R1 and the second part R2 in the width direction. The first part R1 is a planar surface similar to a part in the width direction of the projection surface SC in the first embodiment. The second part R2 is a curved surface that is curved in a concave shape so as to extend toward the front in the illustration as it goes in the width direction from one end of the first part R1 in the width direction.

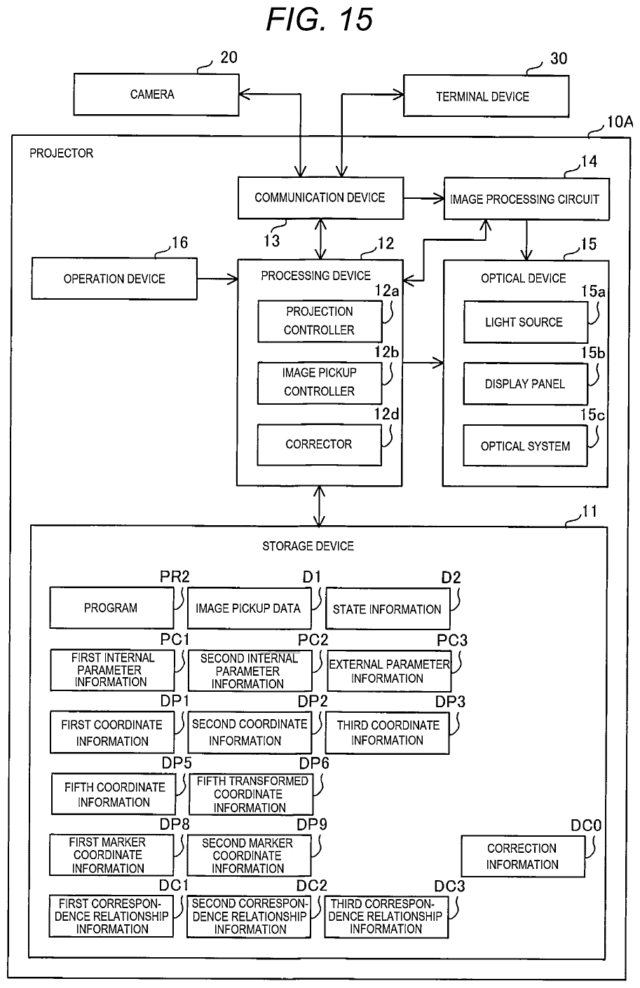

FIG. 15 is a block diagram illustrating the projector 10A used in the system 100A according to the second embodiment. The projector 10A has a configuration similar to the projector 10 in the first embodiment except that a program PR2 is used instead of the program PR1 in the first embodiment.

In the projector 10A, the processing device 12 executes the program PR2 stored in the storage device 11 and thus functions as the projection controller 12a, the image pickup controller 12b, and a corrector 12d. Therefore, the processing device 12 includes the projection controller 12a, the image pickup controller 12b, and the corrector 12d.

The corrector 12d is similar to the corrector 12c in the first embodiment except that, in the estimation of the external parameter, the relationship related to the second part R2, of the first correspondence relationship, is not used, and the relationship related to the first part R1 is used.

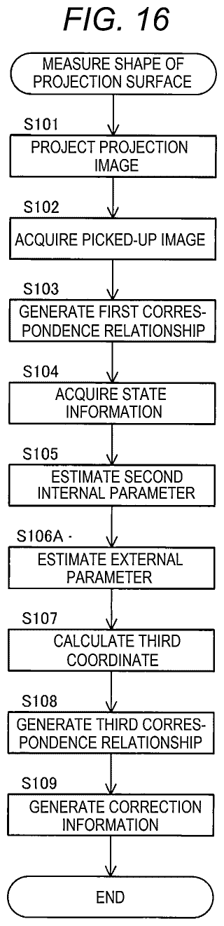

FIG. 16 is a flowchart showing the flow of the measurement of the shape of the projection surface SC in the second embodiment. The projection method according to the present embodiment is similar to the projection method according to the first embodiment except that step S106A is provided instead of step S106 in the first embodiment.

In step S106A, the external parameter is estimated. This estimation is performed by the corrector 12d, based on the first internal parameter, the first correspondence relationship, and the second internal parameter. However, in this estimation, the relationship relating to the second part R2, of the first correspondence relationship, is not used, and the relationship related to the first part R1 is used. Thus, the external parameter can be estimated as in the first embodiment. The estimated external parameter is stored in the storage device 11 as the external parameter information PC3.

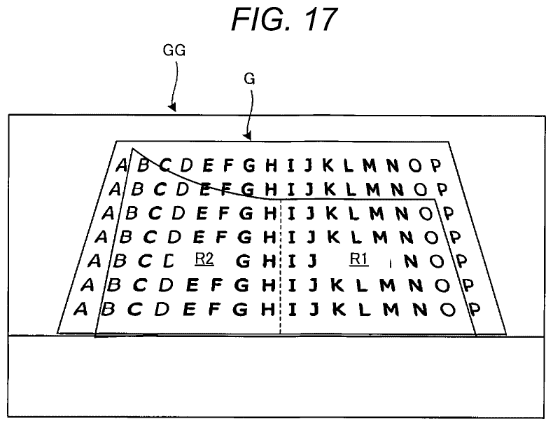

FIG. 17 is a diagram illustrating the measurement of the shape of the first part R1 and the second part R2 of the projection surface SC. FIG. 17 illustrates the picked-up image GG formed by picking up the projection image G projected on the projection surface SC having the first part R1 and the second part R2.

As illustrated in FIG. 17, each of the first part R1 and the second part R2 is captured in the picked-up image GG in the state of overlapping the projection image G. Therefore, as in the first embodiment, in step S107, a plurality of three-dimensional coordinates in the first part R1 and the second part R2 can be calculated by triangulation between the projection surface SC, the camera 20, and the projector 10A, using the second internal parameter information PC2, the external parameter information PC3, and the first correspondence relationship information DC1 that are already acquired.

According to the above second embodiment, a projection method that can save time and effort of the user can be provided.

### 3. Modification Examples

The embodiments described above by way of example can be modified in various manners. Specific aspects of modifications applicable to the foregoing embodiments will be described below by way of example. Two or more aspects freely selected from the examples given below can be combined together as appropriate to the extent that no contradiction occurs.

### 3-1. Modified Example 1

In the foregoing embodiments, an aspect in which the processing device 12 of the projector 10, 10A executes the program PR1, PR2 is described as an example, but the present disclosure is not limited to this aspect, and for example, a processing device of a computer communicably coupled to the projector 10, 10A and the camera 20 may execute the program PR1, PR2.

### 3-2. Modified Example 2

In the foregoing embodiments, an aspect in which the correspondence relationship indicated by the correction information DC0 is used for the adjustment of the projection image G is described as an example, but the present disclosure is not limited to this aspect, and for example, the correspondence relationship may be used for displaying a grid-like pattern or the like having uniformity on the projection surface SC or may be used for drawing a picture on a three-dimensional shaped model of the projection surface SC viewed from the camera 20 after reflecting this model on three-dimensional image editing software or the like, for causing a PC monitor or the like to display how the picture is seen from the projector 10, 10A, or for causing the projector 10, 10A to project the picture.

### 4. Appendices

The present disclosure will be summarized below in the form of appendices.

(Appendix 1) According to a first aspect, which is a preferred example of the projection method according to the present disclosure, a projection method includes: projecting a drawn image drawn on a display panel of a projector onto a projection surface from the projector as a projection image; picking up the projection image with a camera having a first internal parameter and thus acquiring a picked-up image; generating a first correspondence relationship in which a plurality of first coordinates which are coordinates of a plurality of first pixels forming the projection image in the picked-up image and a plurality of second coordinates which are coordinates of a plurality of second pixels forming the drawn image are associated with each other; acquiring state information indicating a state of an optical system of the projector; estimating a second internal parameter which is an internal parameter of the optical system, based on a second correspondence relationship in which the second internal parameter and the state of the optical system are associated with each other, and the state information; and estimating an external parameter indicating one or both of a position and an attitude of the projector in relation to the camera, based on the first internal parameter, the first correspondence relationship, and the second internal parameter.

According to the above aspect, the external parameter is estimated, using the second internal parameter estimated based on the second correspondence relationship and the state information, and therefore a calibration plate for estimating the external parameter need not be prepared. Therefore, a projection method that can save time and effort of the user can be provided.

(Appendix 2) According to a second aspect, which is a preferred example of the first aspect, the projection method includes: calculating a plurality of third coordinates which are three-dimensional coordinates of the projection image on the projection surface, based on the first internal parameter, the second internal parameter, the first correspondence relationship, and the external parameter; and generating a third correspondence relationship in which the plurality of first coordinates and the plurality of third coordinates are associated with each other. According to the above aspect, the third correspondence relationship necessary for various controls can be generated, using the second correspondence relationship.

(Appendix 3) According to a third aspect, which is a preferred example of the first aspect or the second aspect, the projection method further includes adjusting the external parameter in accordance with the temperature of the optical system. According to the above aspect, the external parameter can be suitably adjusted in accordance with the change in the optical characteristics due to the change in the temperature of the optical system.

(Appendix 4) According to a fourth aspect, which is a preferred example of the third aspect, the projection method includes: updating the second internal parameter when the optical system is adjusted; and updating the external parameter, based on the first internal parameter, the first correspondence relationship, and the updated second internal parameter. According to the above aspect, the external parameter can be updated in accordance with the change in the state of the optical system of the projector.

(Appendix 5) According to a fifth aspect, which is a preferred example of one of the second to fourth aspects, the projection method includes: specifying a plurality of fifth coordinates which are coordinates of a plurality of reference points of the projection image on the display panel of the projector; transforming the plurality of fifth coordinates into three-dimensional coordinates, based on a correspondence relationship in which the plurality of second coordinates and the plurality of third coordinates are associated with each other; acquiring three-dimensional coordinates of a marker at a first timing, based on the third correspondence relationship; acquiring three-dimensional coordinates of the marker at a second timing later than the first timing, based on the third correspondence relationship; and adjusting the projection image, based on the three-dimensional coordinates of the marker at the first timing, the three-dimensional coordinates of the marker at the second timing, the coordinates obtained by transforming the plurality of fifth coordinates into three-dimensional coordinates, the first internal parameter, the second internal parameter, and the external parameter. According to the above aspect, even when the projection image at the second timing is displaced in relation to the projection image at the first timing on the projection surface, the projection image can be returned to the state of the projection image at the first timing.

(Appendix 6) According to a sixth aspect, which is a preferred example of the system according to the present disclosure, a system includes a projector and a camera having a first internal parameter, and the projector executes: projecting a projection image onto a projection surface from the projector; picking up the projection image with the camera and thus acquiring a picked-up image; generating a first correspondence relationship in which a plurality of first coordinates which are coordinates of a plurality of first pixels forming the projection image in the picked-up image and a plurality of second coordinates which are coordinates of a plurality of second pixels forming the projection image on a display panel of the projector are associated with each other; acquiring state information indicating a state of an optical system of the projector; estimating a second internal parameter which is an internal parameter of the optical system, based on a second correspondence relationship in which the second internal parameter and the state of the optical system are associated with each other, and the state information; and estimating an external parameter indicating one or both of a position and an attitude of the projector in relation to the camera, based on the first internal parameter, the first correspondence relationship, and the second internal parameter.

According to the above aspect, the external parameter is estimated, using the second internal parameter estimated based on the second correspondence relationship and the state information, and therefore a calibration plate for estimating the external parameter need not be prepared. Therefore, a projection method that can save time and effort of the user can be provided.

(Appendix 7) According to a seventh aspect, which is a preferred example of the program according to the present disclosure, a non-transitory computer-readable storage medium storing a program is provided, the program causing a computer to execute: projecting a projection image onto a projection surface from a projector; picking up the projection image with a camera having a first internal parameter and thus acquiring a picked-up image; generating a first correspondence relationship in which a plurality of first coordinates which are coordinates of a plurality of first pixels forming the projection image in the picked-up image and a plurality of second coordinates which are coordinates of a plurality of second pixels forming the projection image on a display panel of the projector are associated with each other; acquiring state information indicating a state of an optical system of the projector; estimating a second internal parameter which is an internal parameter of the optical system, based on a second correspondence relationship in which the second internal parameter and the state of the optical system are associated with each other, and the state information; and estimating an external parameter indicating one or both of a position and an attitude of the projector in relation to the camera, based on the first internal parameter, the first correspondence relationship, and the second internal parameter.

According to the above aspect, the external parameter is estimated, using the second internal parameter estimated based on the second correspondence relationship and the state information, and therefore a calibration plate for estimating the external parameter need not be prepared. Therefore, a projection method that can save time and effort of the user can be provided.

What is claimed is:

1. A projection method comprising:
projecting a drawn image drawn on a display panel of a projector onto a projection surface from the projector as a projection image;
acquiring a picked-up image by picking up the projection image with a camera having a first internal parameter;
generating a first correspondence relationship in which a plurality of first coordinates which are coordinates of a plurality of first pixels forming the projection image in the picked-up image and a plurality of second coordinates which are coordinates of a plurality of second pixels forming the drawn image are associated with each other;
acquiring state information indicating a state of an optical system of the projector;
estimating a second internal parameter which is an internal parameter of the optical system, based on a second correspondence relationship in which the second internal parameter and the state of the optical system are associated with each other, and the state information; and
estimating an external parameter indicating one or both of a position and an attitude of the projector in relation to the camera, based on the first internal parameter, the first correspondence relationship, and the second internal parameter.

2. The projection method according to claim 1, further comprising:
calculating a plurality of third coordinates which are three-dimensional coordinates of the projection image on the projection surface, based on the first internal parameter, the second internal parameter, the first correspondence relationship, and the external parameter; and
generating a third correspondence relationship in which the plurality of first coordinates and the plurality of third coordinates are associated with each other.

3. The projection method according to claim 1, further comprising:
adjusting the external parameter in accordance with a temperature of the optical system.

4. The projection method according to claim 3, further comprising:
updating the second internal parameter when the optical system is adjusted; and
updating the external parameter, based on the first internal parameter, the first correspondence relationship, and the updated second internal parameter.

5. The projection method according to claim 2, further comprising:
specifying a plurality of fifth coordinates which are coordinates of a plurality of reference points of the projection image on the display panel;
transforming the plurality of fifth coordinates into three-dimensional coordinates, based on a correspondence relationship in which the plurality of second coordinates and the plurality of third coordinates are associated with each other;
acquiring three-dimensional coordinates of a marker at a first timing, based on the third correspondence relationship;
acquiring three-dimensional coordinates of the marker at a second timing later than the first timing, based on the third correspondence relationship; and
adjusting the projection image, based on the three-dimensional coordinates of the marker at the first timing, the three-dimensional coordinates of the marker at the second timing, the coordinates obtained by transforming the plurality of fifth coordinates into three-dimensional coordinates, the first internal parameter, the second internal parameter, and the external parameter.

6. A system comprising:
a projector; and
a camera having a first internal parameter,
the projector executing:
projecting a projection image onto a projection surface from the projector;
acquiring a picked-up image by picking up the projection image with the camera;
generating a first correspondence relationship in which a plurality of first coordinates which are coordinates of a plurality of first pixels forming the projection image in the picked-up image and a plurality of second coordinates which are coordinates of a plurality of second pixels forming the projection image on a display panel of the projector are associated with each other;
acquiring state information indicating a state of an optical system of the projector;
estimating a second internal parameter which is an internal parameter of the optical system, based on a second correspondence relationship in which the second internal parameter and the state of the optical system are associated with each other, and the state information; and
estimating an external parameter indicating one or both of a position and an attitude of the projector in relation to the camera, based on the first internal parameter, the first correspondence relationship, and the second internal parameter.

7. A non-transitory computer-readable storage medium storing a program, the program causing a computer to execute:
projecting a projection image onto a projection surface from a projector;
acquiring a picked-up image by picking up the projection image with a camera having a first internal parameter;
generating a first correspondence relationship in which a plurality of first coordinates which are coordinates of a plurality of first pixels forming the projection image in the picked-up image and a plurality of second coordinates which are coordinates of a plurality of second pixels forming the projection image on a display panel of the projector are associated with each other;
acquiring state information indicating a state of an optical system of the projector;
estimating a second internal parameter which is an internal parameter of the optical system, based on a second correspondence relationship in which the second internal parameter and the state of the optical system are associated with each other, and the state information; and
estimating an external parameter indicating one or both of a position and an attitude of the projector in relation to the camera, based on the first internal parameter, the first correspondence relationship, and the second internal parameter.
